(19) United States
(12) Patent Application Publication
(10) Pub. No.: US 2016/0124274 A1
(43) Pub. Date: May 5, 2016

(54) DISPLAY PANEL AND DISPLAY DEVICE

(71) Applicant: Shenzhen China Star Optoelectronics Technology Co. Ltd., Guangdong (CN)

(72) Inventor: Chuan WU, Guangdong (CN)

(21) Appl. No.: 14/415,719

(22) PCT Filed: Nov. 20, 2014
(86) PCT No.: PCT/CN2014/091743

§ 371 Date: Jan. 19, 2015

(30) Foreign Application Priority Data
Nov. 3, 2014 (CN) 201410613797.2

(51) Int. Cl. G02F 1/1343; G02F 1/1335; G02F 1/1368

(52) U.S. Cl. CPC G02F 1/134309; G02F 1/1368; G02F 1/133514; G02F 1/133512

(57) ABSTRACT

A display panel and a display device are provided. The display panel includes a color filter substrate, a liquid crystal layer, and a thin film transistor array substrate. The color filter substrate includes a first substrate, a color resist array layer, a black matrix layer, a first protective layer, and a common electrode. The thin film transistor array substrate includes a second substrate and a pixel array layer. The pixel array layer is provided with a pixel unit array, a signal line array, and a thin film transistor switch array. A light leakage phenomenon can be effectively prevented.

### FIELD OF THE INVENTION

The present invention relates to a field of display technique, and particularly to a display panel and a display device.

### BACKGROUND OF THE INVENTION

As shown in FIG. 1, FIG. 2, and FIG. 3, a color filter substrate 203 of a conventional display device is generally provided with color resist units and a black matrix layer 2031. The black matrix layer 2031 is used for preventing light leakage, i.e. for preventing a light which should irradiate onto a specific color resist unit from irradiating onto another color resist unit.

For increasing an aperture ratio, a width (i.e. the distance between two adjacent color resist units) of the black matrix layer 2031 is set to be very narrow in the conventional technical solution. The location of the black matrix layer 2031 usually corresponds to the outside region of the pixel units 102 and 103. For example, the black matrix layer 2031 is disposed on a region between the two adjacent pixel units 102 and 103. That is, a scan line or a data line between the two adjacent pixel units 102 and 103 is shielded by the black matrix layer 2031.

However, in this situation, if a shift (for example, the shift distance is D1) between the color filter substrate 203 and a thin film transistor array substrate 201 occurs after they are aligned and assembled, a light leakage region 301 will be generated on the display device due to the shift. Light may emit from the light leakage region 301, thereby showing mura defects (brightness non-uniformity phenomenon) on an image displayed by the display device.

Therefore, it is necessary to provide a new technical solution to solve the above technical problems.

### SUMMARY OF THE INVENTION

An object of the present invention is to provide a display panel and a display device, which prevents a light leakage phenomenon caused by a shift between a thin film transistor array substrate and a color filter substrate.

In order to solve the above-mentioned problem, the technical solution of the present invention is as follows:

A display panel, the display panel comprises: a color filter substrate comprising: a first substrate, a color resist array layer disposed on the first substrate, a black matrix layer disposed on the first substrate, a first protective layer disposed on the color resist array layer and the black matrix layer, and a common electrode disposed on the first protective layer; a liquid crystal layer; and a thin film transistor array substrate comprising: a second substrate and a pixel array layer disposed on the second substrate. The pixel array layer is provided with a pixel unit array, a signal line array, and a thin film transistor switch array. The color filter substrate and the thin film transistor array substrate are aligned and assembled together. The liquid crystal layer is disposed between the color filter substrate and the thin film transistor array substrate. The signal line array comprises at least one signal line. The pixel unit array comprises at least two pixel units which are arranged in an array. There is a space between the two adjacent pixel units. The signal line is disposed in the space. The black matrix layer comprises at least one grid which comprises a light-leakage-proof strip. A location of the light-leakage-proof strip corresponds to the space. A compensation electrode is disposed in the space. The pixel array layer further comprises a shield electrode. The shield electrode is located between the second substrate and a pixel electrode which is located in the pixel unit.

In the above-mentioned display panel, a first sub-space and a second sub-space are respectively formed between the signal line and the two adjacent pixel units. The compensation electrode comprises a first sub-electrode and a second sub-electrode. The first sub-electrode is disposed in the first sub-space. The second sub-electrode is disposed in the second sub-space.

In the above-mentioned display panel, a voltage received by the first sub-electrode is the same as a voltage at the common electrode. A voltage received by the second sub-electrode is the same as the voltage at the common electrode.

In the above-mentioned display panel, the first sub-electrode is used for controlling liquid crystal molecules between the first sub-electrode and the common electrode to shield a light irradiating onto the first sub-space when a relative position of the light-leakage-proof strip with respect to the signal line in a direction perpendicular to the signal line is changed. The second sub-electrode is used for controlling liquid crystal molecules between the second sub-electrode and the common electrode to shield a light irradiating onto the second sub-space when the relative position of the light-leakage-proof strip with respect to the signal line in the direction perpendicular to the signal line is changed.

A display panel, the display panel comprises: a color filter substrate comprising: a first substrate, a color resist array layer disposed on the first substrate, a black matrix layer disposed on the first substrate, a first protective layer disposed on the color resist array layer and the black matrix layer, and a common electrode disposed on the first protective layer; a liquid crystal layer; and a thin film transistor array substrate comprising: a second substrate and a pixel array layer disposed on the second substrate. The pixel array layer is provided with a pixel unit array, a signal line array, and a thin film transistor switch array. The color filter substrate and the thin film transistor array substrate are aligned and assembled together. The liquid crystal layer is disposed between the color filter substrate and the thin film transistor array substrate.

In the above-mentioned display panel, the signal line array comprises at least one signal line. The pixel unit array comprises at least two pixel units which are arranged in an array. There is a space between the two adjacent pixel units. The signal line is disposed in the space. The black matrix layer comprises at least one grid which comprises a light-leakage-proof strip. A location of the light-leakage-proof strip corresponds to the space. A compensation electrode is disposed in the space.

In the above-mentioned display panel, the compensation electrode is located on a surface where a pixel electrode of the pixel unit is located.

In the above-mentioned display panel, a first sub-space and a second sub-space are respectively formed between the signal line and the two adjacent pixel units. The compensation electrode comprises a first sub-electrode and a second sub-electrode. The first sub-electrode is disposed in the first sub-space. The second sub-electrode is disposed in the second sub-space.

In the above-mentioned display panel, a voltage received by the first sub-electrode is the same as a voltage at the common electrode. A voltage received by the second sub-electrode is the same as the voltage at the common electrode.

In the above-mentioned display panel, the first sub-electrode is used for controlling liquid crystal molecules between the first sub-electrode and the common electrode to shield a light irradiating onto the first sub-space when a relative position of the light-leakage-proof strip with respect to the signal line in a direction perpendicular to the signal line is changed. The second sub-electrode is used for controlling liquid crystal molecules between the second sub-electrode and the common electrode to shield a light irradiating onto the second sub-space when the relative position of the light-leakage-proof strip with respect to the signal line in the direction perpendicular to the signal line is changed.

In the above-mentioned display panel, the first sub-electrode is used for controlling the liquid crystal molecules between the first sub-electrode and the common electrode not to rotate. The second sub-electrode is used for controlling the liquid crystal molecules between the second sub-electrode and the common electrode not to rotate.

In the above-mentioned display panel, a width of the first sub-electrode is equal to or greater than a width of the first sub-space. A width of the second sub-electrode is equal to or greater than a width of the second sub-space.

A display device, the display device comprises: a backlight module and a display panel, where the display panel is superposed on and assembled with the backlight module. The display panel comprises: a color filter substrate comprising: a first substrate, a color resist array layer disposed on the first substrate, a black matrix layer disposed on the first substrate, a first protective layer disposed on the color resist array layer and the black matrix layer, and a common electrode disposed on the first protective layer; a liquid crystal layer; and a thin film transistor array substrate comprising: a second substrate and a pixel array layer disposed on the second substrate. The pixel array layer is provided with a pixel unit array, a signal line array, and a thin film transistor switch array. The color filter substrate and the thin film transistor array substrate are aligned and assembled together. The liquid crystal layer is disposed between the color filter substrate and the thin film transistor array substrate.

In the above-mentioned display device, the signal line array comprises at least one signal line. The pixel unit array comprises at least two pixel units which are arranged in an array. There is a space between the two adjacent pixel units. The signal line is disposed in the space. The black matrix layer comprises at least one grid which comprises a light-leakage-proof strip. A location of the light-leakage-proof strip corresponds to the space. A compensation electrode is disposed in the space.

In the above-mentioned display device, the compensation electrode is located on a surface where a pixel electrode of the pixel unit is located.

In the above-mentioned display device, a first sub-space and a second sub-space are respectively formed between the signal line and the two adjacent pixel units. The compensation electrode comprises a first sub-electrode and a second sub-electrode. The first sub-electrode is disposed in the first sub-space. The second sub-electrode is disposed in the second sub-space.

In the above-mentioned display device, a voltage received by the first sub-electrode is the same as a voltage at the common electrode. A voltage received by the second sub-electrode is the same as the voltage at the common electrode.

In the above-mentioned display device, the first sub-electrode is used for controlling liquid crystal molecules between the first sub-electrode and the common electrode to shield a light irradiating onto the first sub-space when a relative position of the light-leakage-proof strip with respect to the signal line in a direction perpendicular to the signal line is changed. The second sub-electrode is used for controlling liquid crystal molecules between the second sub-electrode and the common electrode to shield a light irradiating onto the second sub-space when the relative position of the light-leakage-proof strip with respect to the signal line in the direction perpendicular to the signal line is changed.

In the above-mentioned display device, the first sub-electrode is used for controlling the liquid crystal molecules between the first sub-electrode and the common electrode not to rotate. The second sub-electrode is used for controlling the liquid crystal molecules between the second sub-electrode and the common electrode not to rotate.

In the above-mentioned display device, a width of the first sub-electrode is equal to or greater than a width of the first sub-space. A width of the second sub-electrode is equal to or greater than a width of the second sub-space.

In comparison with the prior art, the present invention can effectively prevent the light leakage phenomenon caused by a shift between the thin film transistor array substrate and a color filter substrate.

In order to make the present invention more clear, preferred embodiments and the drawings thereof are described in detail below.

### BRIEF DESCRIPTION OF THE DRAWINGS

FIG. 1 is a partial schematic diagram of a conventional display panel.

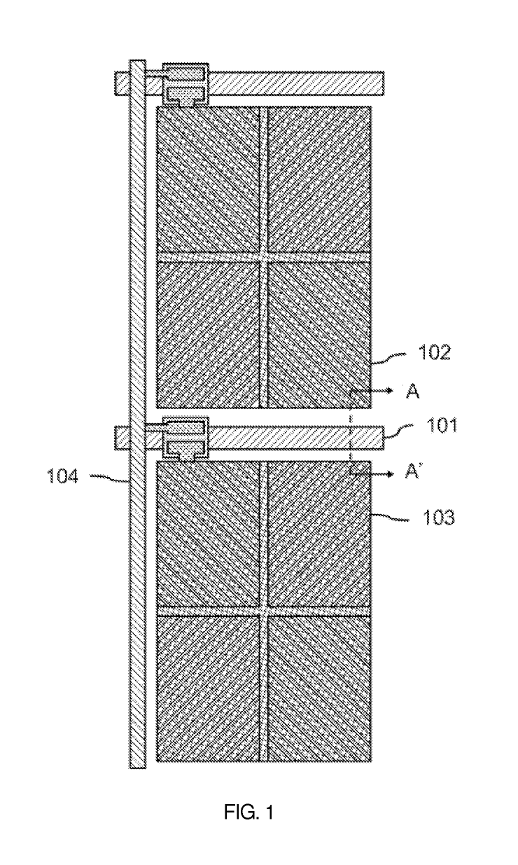

FIG. 2 is a schematic diagram taken from section A-A′ of the display panel of FIG. 1, where a shift between a top substrate and a bottom substrate occurs.

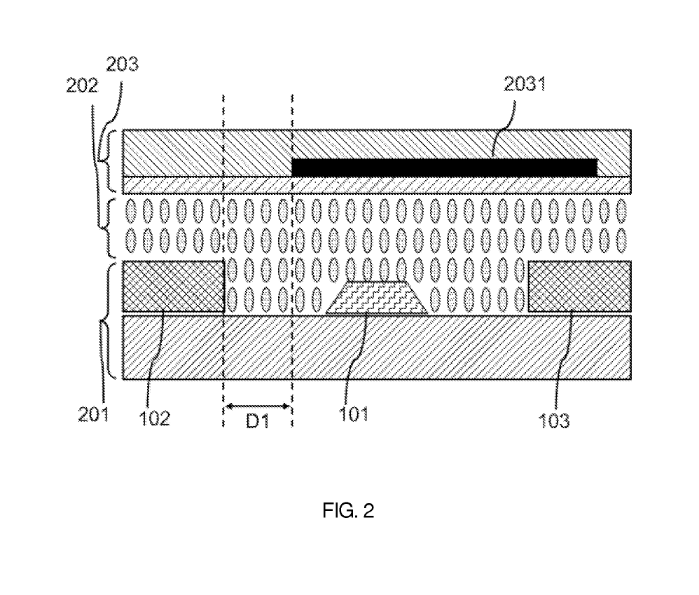

FIG. 3 is a schematic diagram of a light leakage phenomenon in the display panel shown in FIG. 2.

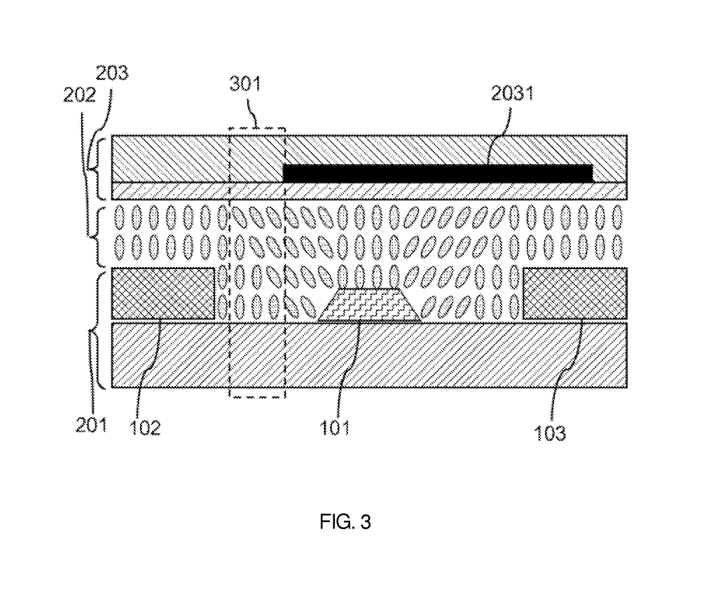

FIG. 4 is an isometric diagram of a display device of the present invention.

FIG. 5 is a partial schematic diagram of the display panel shown in FIG. 4.

FIG. 6 is a schematic diagram taken from section B-B′ of the display panel shown in FIG. 5, where a first kind of shift situation occurs.

FIG. 7 is a schematic diagram taken from section B-B′ of the display panel shown in FIG. 6, where a second kind of shift situation occurs.

### DETAILED DESCRIPTION OF THE INVENTION

The term “embodiment” is used herein to mean serving as an example, instance, or illustration. In addition, the articles “a” and “an” as used in this application and the appended claims should generally be construed to mean “one or more” unless specified otherwise or clear from the context to be directed to a singular form.

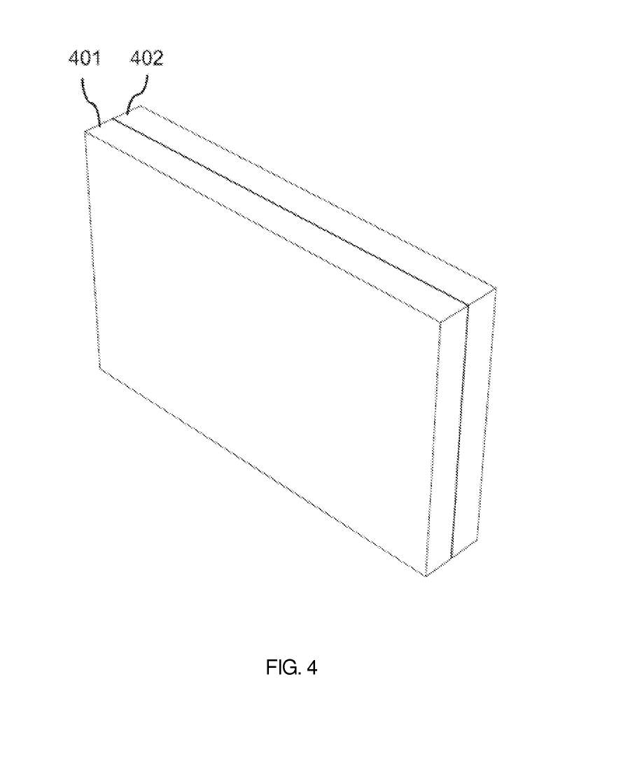

Refer to FIG. 4, which shows an isometric diagram of a display device of the present invention.

In this embodiment, the display device comprises a backlight module 402 and a display panel 401. The display panel 401 is superposed on and assembled with the backlight module 402.

In this embodiment, the display device may be either a flat display device or a curved display device. The display panel 401 may be either a flat display panel or a curved display panel. In the situation that the display device is a curved display device, the backlight module 402 is a curved backlight module and the display panel 401 is a curved display panel. In the situation that the display panel 401 is a curved display panel, the curved display panel is formed by bending a flat display panel.

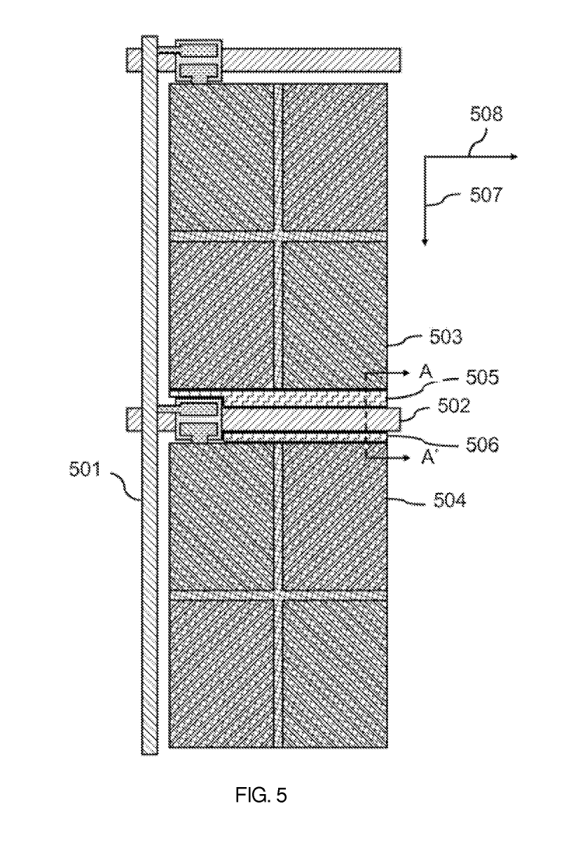

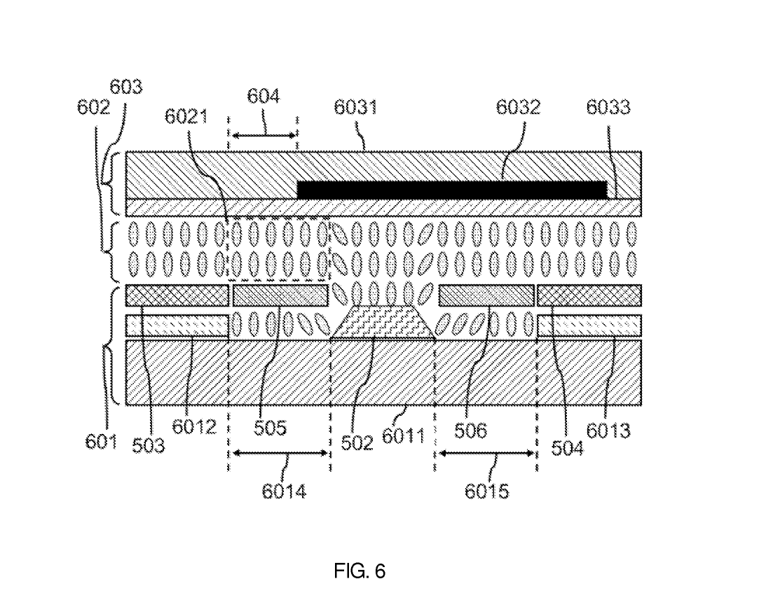

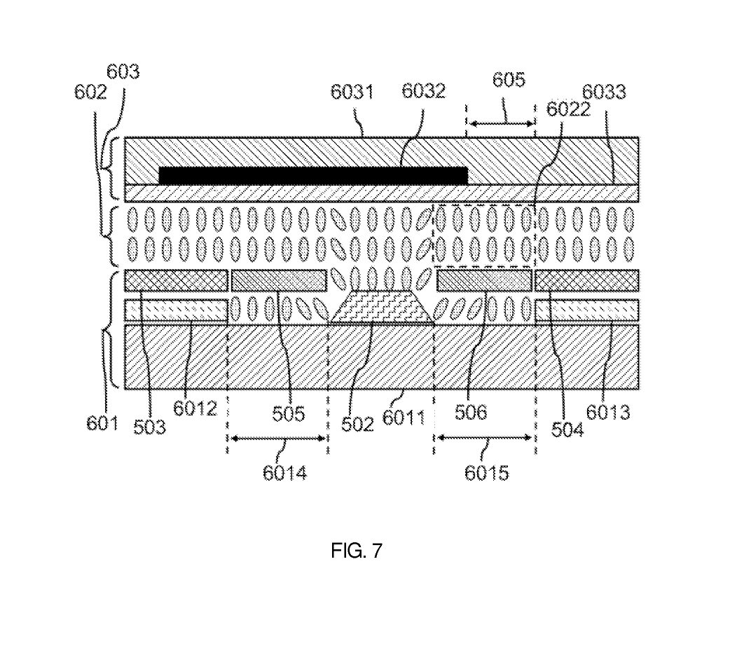

Refer to FIG. 5, FIG. 6, and FIG. 7. FIG. 5 is a partial schematic diagram of the display panel 401 shown in FIG. 4. FIG. 6 is a schematic diagram taken from section B-B′ of the display panel 401 shown in FIG. 5, where a first kind of shift situation occurs. In addition, FIG. 7 is a schematic diagram taken from section B-B′ of the display panel 401 shown in FIG. 6, where a second kind of shift situation occurs.

The display panel 401 comprises a color filter substrate 603, a liquid crystal layer 602, and a thin film transistor array substrate 601. The color filter substrate 603 and the thin film transistor array substrate 601 are aligned and assembled together. The liquid crystal layer 602 is disposed between the color filter substrate 603 and the thin film transistor array substrate 601.

The color filter substrate 603 comprises a first substrate 6031, a color resist array layer (not shown in the Figures), a black matrix layer, a first protective layer, and a common electrode 6033. The color resist array layer is disposed on the first substrate 6031. The black matrix layer is disposed on the first substrate 6031. The first protective layer is disposed on the color resist array layer and the black matrix layer. The common electrode 6033 is disposed on the first protective layer.

The thin film transistor array substrate 601 comprises a second substrate 6011 and a pixel array layer. The pixel array layer is disposed on the second substrate 6011. The pixel array layer is provided with a pixel unit array, a signal line array, and a thin film transistor switch array.

In this embodiment, the signal line array comprises at least one signal line. The signal line array comprises a data line array and a scan line array. The scan line array comprises at least one scan line 502. The data line array comprises at least one data line 501. That is, the signal line comprises the scan line 502 and the data line 501. The thin film transistor switch array comprises at least one thin film transistor switch. The pixel unit array comprises at least one pixel unit 503 and 504. The at least two pixel units 503 and 504 are arranged in an array along a first direction 507 or along a second direction 508. The first direction 507 is perpendicular to the scan line 502 in a plane of the pixel array layer. The second direction 508 is perpendicular to the data line 501 in the plane of the pixel array layer. There is a space between the two adjacent pixel units 503 and 504 in the first direction 507 or the second direction 508. The signal line (such as the scan line 502 or the data line 501) is disposed in the space.

The black matrix layer is formed in a grid shape, and the black matrix layer comprises at least one grid. Each grid of the black matrix layer is composed of at least four sections. The grid is formed by connecting end-to-end four sections. Each section is a light-leakage-proof strip 6032. A location of the light-leakage-proof strip 6032 corresponds to the space. A straight line where the light-leakage-proof strip 6032 is located is parallel to a straight line where the signal line is located. The space is shielded by the light-leakage-proof strip 6032.

A color resist unit of the color resist array layer is disposed in the grid. A compensation electrode is disposed in the space.

In this embodiment, a first sub-space 6014 and a second sub-space 6015 are respectively formed between the signal line and the two adjacent pixel units 503 and 504.

The compensation electrode comprises a first sub-electrode 505 and a second sub-electrode 506. The first sub-electrode 505 is disposed in the first sub-space 6014. The second sub-electrode 506 is disposed in the second sub-space 6015.

Preferably, a width of the first sub-electrode 505 is greater than or equal to a width of the first sub-space 6014. A width of the second sub-electrode 506 is greater than or equal to a width of the second sub-space 6015. The values of the first sub-space 6014 and the second sub-space 6015 may be between 0 and 10 um (micrometers).

In this embodiment, a voltage received by the first sub-electrode 505 is the same as a voltage at the common electrode 6033. A voltage received by the second sub-electrode 506 is the same as the voltage at the common electrode 6033.

As shown in FIG. 6, in this embodiment, if a first kind of shift situation occurs in the display panel 401, i.e. a shift (position is shifted) between the color filter substrate 603 and the thin film transistor array substrate 601 in a direction (such as the first direction 507 or the second direction 508) perpendicular to the signal line, the first sub-space 6014 cannot be entirely shielded by the light-leakage-proof strip 6032. That is, at least one portion of the first sub-space 6014 is overlapped (overlap region 604) with the corresponding color resist unit in a direction perpendicular to the plane of the thin film transistor array substrate 601. When a relative position of the light-leakage-proof strip 6032 with respect to the signal line in a direction (such as the first direction 507 or the second direction 508) perpendicular to the signal line is changed, the first sub-electrode 505 is used for controlling liquid crystal molecules 6021 between the first sub-electrode 505 and the common electrode 6033 to shield a light irradiating onto the first sub-space 6014.

As shown in FIG. 7, if a second kind of shift situation occurs in the display panel 401, i.e. a shift between the color filter substrate 603 and the thin film transistor array substrate 601 in an opposite direction (such as the first direction 507 or the second direction 508) perpendicular to the signal line, the second sub-space 6015 cannot be entirely shielded by the light-leakage-proof strip 6032. That is, at least one portion of the second sub-space 6015 is overlapped (overlap region 605) with the corresponding color resist unit in a direction perpendicular to the plane of the thin film transistor array substrate 601. When a relative position of the light-leakage-proof strip 6032 with respect to the signal line in a direction (such as the first direction 507 or the second direction 508) perpendicular to the signal line is changed, the second sub-electrode 506 is used for controlling liquid crystal molecules 6022 between the second sub-electrode 506 and the common electrode 6033 to shield a light irradiating onto the second sub-space 6015.

To be more specific, a voltage at the first sub-electrode 505 is the same as a voltage at the common electrode 6033. The first sub-electrode 505 is used for controlling the liquid crystal molecules 6021 between the first sub-electrode 505 and the common electrode 6033 not to rotate. A voltage at the second sub-electrode 506 is the same as the voltage at the common electrode 6033. The second sub-electrode 506 is used for controlling the liquid crystal molecules 6022 between the second sub-electrode 506 and the common electrode 6033 not to rotate.

The pixel array layer further comprises shield electrodes 6012 and 6013. The shield electrodes 6012 and 6013 are located between the second substrate 6011 and the pixel electrodes which are located in the pixel units 503 and 504.

The compensation electrode is located on a plane where the pixel electrodes of the pixel units 503 and 504 are located. That is, a plane where the compensation electrode is located is the same as a plane where the pixel electrode is located.

In the above-mentioned technical solution, since the first sub-electrode 505 and the second sub-electrode 506 are disposed in the spaces (the first sub-space 6014 and the second sub-space 6015) which are located between the signal line and the two pixel units 503 and 504 adjacent on both sides thereof, and a voltage difference between first sub-electrode 505 and the second sub-electrode 506 and the common electrode 6033 are zero, light emitted from the first sub-space 6014 and the second sub-space 6015 can be shielded by the liquid crystal molecules 6021 and 6022 between the first sub-electrode 505 and the second sub-electrode 506 and the common electrode 6033, thereby effectively preventing light leakage phenomenon from the first sub-space 6014 and the second sub-space 6015.

That is, in the situation that the shift between the thin film transistor array substrate and the color filter substrate occurs, a light leakage phenomenon can be effectively prevented by the technical solution of the present invention.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular, with regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such a feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The above descriptions are merely preferable embodiments of the present invention, but are not intended to limit the scope of the present invention. Any modification or replacement made by those skilled in the art without departing from the spirit and principle of the present invention should fall within the protection scope of the present invention. Therefore, the protection scope of the present invention is subject to the appended claims.

What is claimed is:

1. A display panel, comprising:
a color filter substrate, comprising:
a first substrate;
a color resist array layer disposed on the first substrate;
a black matrix layer disposed on the first substrate;
a first protective layer disposed on the color resist array layer and the black matrix layer; and
a common electrode disposed on the first protective layer;
a liquid crystal layer; and
a thin film transistor array substrate, comprising:
a second substrate; and
a pixel array layer disposed on the second substrate, the pixel array layer being provided with a pixel unit array, a signal line array, and a thin film transistor switch array;
wherein the color filter substrate and the thin film transistor array substrate are aligned and assembled together, the liquid crystal layer is disposed between the color filter substrate and the thin film transistor array substrate;
the signal line array comprises at least one signal line;
the pixel unit array comprises at least two pixel units which are arranged in an array, there is a space between the two adjacent pixel units, the signal line is disposed in the space;
the black matrix layer comprises at least one grid which comprises a light-leakage-proof strip, a location of the light-leakage-proof strip corresponds to the space;
a compensation electrode is disposed in the space;
the pixel array layer further comprises a shield electrode, the shield electrode is located between the second substrate and a pixel electrode which is located in the pixel unit.

2. The display panel according to claim 1, wherein a first sub-space and a second sub-space are respectively formed between the signal line and the two adjacent pixel units;
the compensation electrode comprises a first sub-electrode and a second sub-electrode, the first sub-electrode is disposed in the first sub-space, the second sub-electrode is disposed in the second sub-space.

3. The display panel according to claim 2, wherein a voltage received by the first sub-electrode is the same as a voltage at the common electrode;
a voltage received by the second sub-electrode is the same as the voltage at the common electrode.

4. The display panel according to claim 3, wherein the first sub-electrode is used for controlling liquid crystal molecules between the first sub-electrode and the common electrode to shield a light irradiating onto the first sub-space when a relative position of the light-leakage-proof strip with respect to the signal line in a direction perpendicular to the signal line is changed;
the second sub-electrode is used for controlling liquid crystal molecules between the second sub-electrode and the common electrode to shield a light irradiating onto the second sub-space when the relative position of the light-leakage-proof strip with respect to the signal line in the direction perpendicular to the signal line is changed.

5. A display panel, comprising:
a color filter substrate, comprising:
a first substrate;
a color resist array layer disposed on the first substrate;
a black matrix layer disposed on the first substrate;
a first protective layer disposed on the color resist array layer and the black matrix layer; and
a common electrode disposed on the first protective layer;
a liquid crystal layer; and
a thin film transistor array substrate, comprising:
a second substrate; and
a pixel array layer disposed on the second substrate, the pixel array layer being provided with a pixel unit array, a signal line array, and a thin film transistor switch array;
wherein the color filter substrate and the thin film transistor array substrate are aligned and assembled together, the liquid crystal layer is disposed between the color filter substrate and the thin film transistor array substrate.

6. The display panel according to claim 5, wherein the signal line array comprises at least one signal line;
the pixel unit array comprises at least two pixel units which are arranged in an array, there is a space between the two adjacent pixel units, the signal line is disposed in the space;
the black matrix layer comprises at least one grid which comprises a light-leakage-proof strip, a location of the light-leakage-proof strip corresponds to the space;
a compensation electrode is disposed in the space.

7. The display panel according to claim 6, wherein the compensation electrode is located on a surface where a pixel electrode of the pixel unit is located.

8. The display panel according to claim 6, wherein a first sub-space and a second sub-space are respectively formed between the signal line and the two adjacent pixel units;
the compensation electrode comprises a first sub-electrode and a second sub-electrode, the first sub-electrode is disposed in the first sub-space, the second sub-electrode is disposed in the second sub-space.

9. The display panel according to claim 8, wherein a voltage received by the first sub-electrode is the same as a voltage at the common electrode;
a voltage received by the second sub-electrode is the same as the voltage at the common electrode.

10. The display panel according to claim 9, wherein the first sub-electrode is used for controlling liquid crystal molecules between the first sub-electrode and the common electrode to shield a light irradiating onto the first sub-space when a relative position of the light-leakage-proof strip with respect to the signal line in a direction perpendicular to the signal line is changed;
the second sub-electrode is used for controlling liquid crystal molecules between the second sub-electrode and the common electrode to shield a light irradiating onto the second sub-space when the relative position of the light-leakage-proof strip with respect to the signal line in the direction perpendicular to the signal line is changed.

11. The display panel according to claim 10, wherein the first sub-electrode is used for controlling the liquid crystal molecules between the first sub-electrode and the common electrode not to rotate; the second sub-electrode is used for controlling the liquid crystal molecules between the second sub-electrode and the common electrode not to rotate.

12. The display panel according to claim 8, wherein a width of the first sub-electrode is equal to or greater than a width of the first sub-space; a width of the second sub-electrode is equal to or greater than a width of the second sub-space.

13. A display device, comprising:
a backlight module; and
a display panel, wherein the display panel is superposed on and assembled with the backlight module, the display panel comprises:
a color filter substrate, comprising:
a first substrate;
a color resist array layer disposed on the first substrate;
a black matrix layer disposed on the first substrate;
a first protective layer disposed on the color resist array layer and the black matrix layer; and
a common electrode disposed on the first protective layer;
a liquid crystal layer; and
a thin film transistor array substrate, comprising:
a second substrate; and
a pixel array layer disposed on the second substrate, the pixel array layer being provided with a pixel unit array, a signal line array, and a thin film transistor switch array;
wherein the color filter substrate and the thin film transistor array substrate are aligned and assembled together, the liquid crystal layer is disposed between the color filter substrate and the thin film transistor array substrate.

14. The display device according to claim 13, wherein the signal line array comprises at least one signal line;
the pixel unit array comprises at least two pixel units which are arranged in an array, there is a space between the two adjacent pixel units, the signal line is disposed in the space;
the black matrix layer comprises at least one grid which comprises a light-leakage-proof strip, a location of the light-leakage-proof strip corresponds to the space;
a compensation electrode is disposed in the space.

15. The display device according to claim 14, wherein the compensation electrode is located on a surface where a pixel electrode of the pixel unit is located.

16. The display device according to claim 14, wherein a first sub-space and a second sub-space are respectively formed between the signal line and the two adjacent pixel units;
the compensation electrode comprises a first sub-electrode and a second sub-electrode, the first sub-electrode is disposed in the first sub-space, the second sub-electrode is disposed in the second sub-space.

17. The display device according to claim 16, wherein a voltage received by the first sub-electrode is the same as a voltage at the common electrode;
a voltage received by the second sub-electrode is the same as the voltage at the common electrode.

18. The display device according to claim 17, wherein the first sub-electrode is used for controlling liquid crystal molecules between the first sub-electrode and the common electrode to shield a light irradiating onto the first sub-space when a relative position of the light-leakage-proof strip with respect to the signal line in a direction perpendicular to the signal line is changed;
the second sub-electrode is used for controlling liquid crystal molecules between the second sub-electrode and the common electrode to shield a light irradiating onto the second sub-space when the relative position of the light-leakage-proof strip with respect to the signal line in the direction perpendicular to the signal line is changed.

19. The display device according to claim 18, wherein the first sub-electrode is used for controlling the liquid crystal molecules between the first sub-electrode and the common electrode not to rotate; the second sub-electrode is used for controlling the liquid crystal molecules between the second sub-electrode and the common electrode not to rotate.

20. The display device according to claim 16, wherein a width of the first sub-electrode is equal to or greater than a width of the first sub-space; a width of the second sub-electrode is equal to or greater than a width of the second sub-space.
